(19) United States
(12) Patent Application Publication
(10) Pub. No.: US 2007/0074198 A1
(43) Pub. Date: Mar. 29, 2007

(54) Deciding redistribution servers by hop count

(75) Inventors: Paul A. Gassoway, Norwood, MA (US); John L. Gargiulo, Garden City, NY (US)

Correspondence Address: BAKER BOTTS L.L.P., 2001 ROSS AVENUE, SUITE 600, DALLAS, TX, 75201-2980, US

(73) Assignee: Computer Associates Think, Inc.

(21) Appl. No.: 11/218,263

(22) Filed: Aug. 31, 2005

(51) Int. Cl. G06F 9/44

(52) U.S. Cl. 717/168

(57) ABSTRACT

A system and method are provided for updating software on a client computer including accessing a list of available redistribution servers in a network wherein each redistribution server includes particular software for download. A hop count is determined between a client computer and a plurality of the redistribution servers on the list of available redistribution servers, and the software is requested from a redistribution server with the lowest determined hop count.

### TECHNICAL FIELD OF THE INVENTION

This invention relates generally to the field of efficiently updating software on client computers of a network and more specifically to a system and method of deciding redistribution servers by hop count.

### BACKGROUND

Redistribution servers are servers that can download software packages from an origination server and make those software packages available to other computers on a network. Redistribution servers allow a greater number of client computers to download the software package at the same time as the download requests are divided among the redistribution servers.

Network administrators familiar with a computer network may assign a hierarchy of redistribution servers to each client computer. Changes in network topology or growth of the network may result in these assignments becoming obsolete or inefficient. The network administrator may need to frequently manually update the assignments for each client computer, which can be a lengthy and difficult process and requires a comprehensive knowledge of the network topology.

In medium to large networks, there may be too many client computers for one redistribution server to handle. Furthermore, it is desirable to have more than one redistribution server so that if a redistribution server is inoperable, client computers can download software from a redundant server. It is a significant undertaking for a network administrator to assign to a large number of client computers a list of redistribution servers while maintaining maximum network efficiency.

### SUMMARY

In accordance with the teachings of the present invention, the disadvantages and problems associated with managing software package downloads from multiple redistribution servers to network client computers have been substantially reduced or eliminated. In particular, the system and method described herein provide for ranking redistribution servers based on hop counts between the redistribution servers and particular client computers or subnets.

In accordance with one embodiment of the present invention, a system and method are provided for updating software on a client computer including accessing a list of available redistribution servers in a network wherein each redistribution server includes particular software for download. A hop count is determined between a client computer and a plurality of the redistribution servers on the list of available redistribution servers, and the software is requested from a redistribution server with the lowest determined hop count.

In accordance with another embodiment of the present invention, a system and method for updating software on a network are provided, including accessing a list of subnets, the subnets including at least one client computer. A list of redistribution servers available to each subnet is also accessed. A first client computer on at least one subnet is directed to determine a first hop count between the first client computer and a first redistribution server available to the at least one subnet, and to determine a second hop count between the first client computer and a second redistribution server available to the at least one subnet. A table is compiled associating the first redistribution server with the first hop count and the second redistribution server with the second hop count.

Technical advantages of certain embodiments of the present invention may include efficient updating of software residing on networked client computers from a plurality of redistribution servers by ranking the redistribution servers based on a hop count between the redistribution servers and the client computers. Each client computer may be presented a list of redistribution servers available to the client computer to download software updates. The client computer may then determine the hop count between itself and each of the redistribution servers. The client computer may then download the software package from the redistribution server with the lowest hop count, thereby minimizing the number of intermediate network components the software package must be passed through and maximizing the efficient use of the network.

Another technical advantage of particular embodiments of the present invention may include a reduction in network traffic by allowing one client computer of a subnet to compile a list of hop counts to a plurality of redistribution servers as a representative for the subnet. Any particular subnet may have a plurality of client computers that are similarly situated. A representative client computer may compile a hop count list and make it available to each of the other client computers on the subnet. Alternatively, the client computer may report the list to an administration server, which may make the list available to each of the other client computers on the subnet. The administration server may also coordinate the compiling of hop count lists across the network for multiple subnets.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

To provide a more complete understanding of the present invention and the features and advantages thereof, reference is made to the following description, taken in conjunction with the accompanying drawings, in which:

FIG. 1 illustrates a network including redistribution servers and client computers in accordance with the present invention;

FIG. 2 illustrates a table listing redistribution servers available to a client computer and hop counts associated with each of those redistribution servers in accordance with the present invention;

FIG. 3 illustrates a table that may be created by an administration server to compile redistribution server hop count information for a plurality of subnets; and

FIG. 4 is a flowchart illustrating a method of ranking redistribution servers based on hop count in accordance with the present invention.

### DETAILED DESCRIPTION OF THE INVENTION

Efficient downloading of a software package for a particular client computer may be at least partially determined by the number of hops, or the number of intermediate network components, present between the client computer and the redistribution server. The number of hops between a client computer and a redistribution server is known as the hop count. Redistribution servers having higher hop counts from a particular client computer may be less efficient servers to download software packages from than redistribution servers having lower hop counts.

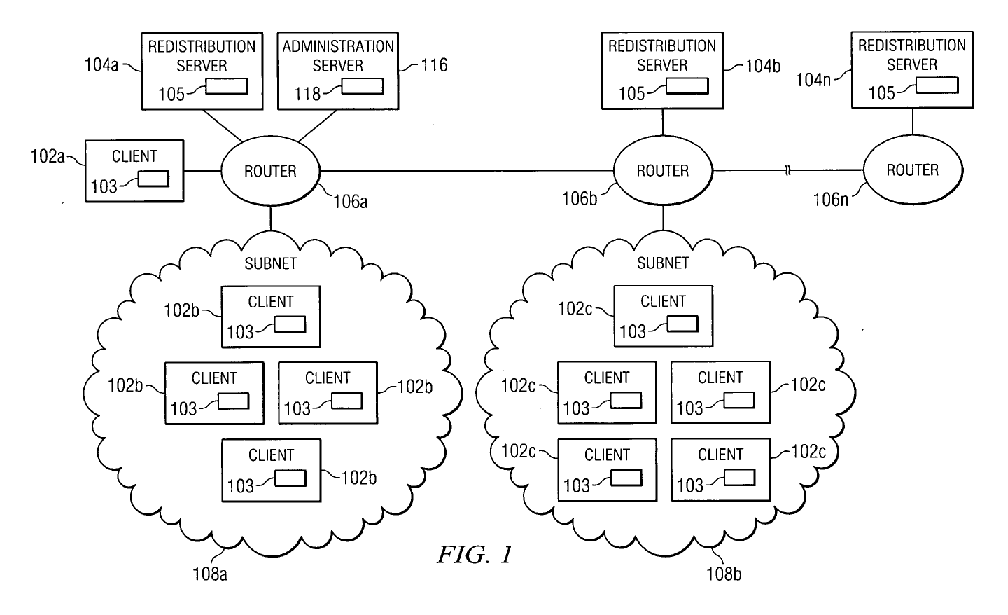

FIG. 1 illustrates a computer network with a plurality of client computers 102 and a plurality of redistribution servers 104. Client computers 102 may update software programs resident on the client computers by downloading files or software packages 105 resident on the redistribution servers 104. The efficiency of the computer network may be improved by designating redistribution servers 104 from which each client computer 102 should download software package 105. In a large computer network, it is inefficient for all client computers 102 to attempt to download from a single server. Furthermore, a particular server may be unavailable for various reasons at a specific time. Client computers 102 may determine individually, or on a subnet basis, which redistribution server 104 is the closest to them on the network and download software package 105 from the closest available redistribution server 104. In this way, all client computers 102 are not downloading from a single redistribution server 104, and each download is occurring over the appropriate available route on the network.

In a particular embodiment, the computer program resident on client computer 102 may be, for example, a virus detection program. The virus detection program may have updates available to it on redistribution servers 104. The downloadable software package 105 may include, for example, virus signature files. Virus signature files may be periodically created by a service provider and packaged into software package 105. Software package 105 may then be distributed to redistribution servers 104 to be downloaded to client computers 102. In alternative embodiments, software package 105 may include updates to any programs resident on client computers 102, or may include installation files for network installations of computer programs.

Any particular client computer 102 could potentially download from any redistribution server 104a, 104b, . . . or 140n as each redistribution server 104 includes the same software package 105. However, it is most efficient for a client computer 102 to download software package 105 from the redistribution server 104 closest to the client computer 102 on the network so as to minimize the number of hand-offs between intermediate network components, such as routers 106. For example, it would be more efficient for client computer 102a to download software package 105 from redistribution server 104a than to download software package 105 from redistribution server 104b. This is the case because between client computer 102a and redistribution server 104a there is only one intermediate network component: router 106a. Between client computer 102a and redistribution server 104b, there are two intermediate network components: router 106a and router 106b. Therefore downloading software package 105 from redistribution server 104a would require fewer hand-offs between intermediate network components than downloading software package 105 from redistribution server 104b.

In a small to medium sized network, a network administrator or IT staff may be able to manually determine which redistribution server 104 is the most efficient for each client computer 102 to download from. However, changes in network topology may require continuous reevaluation and updating to ensure that each client computer 102 is downloading from the appropriate redistribution server 104. Additionally, it may not be practical or feasible in a large network to manually determine for each client computer 102 the most efficient redistribution server 104. Therefore, it is desirable for a client computer 102 to be able to determine for itself the most efficient redistribution server 104 from which to download software 105. Allowing client computer 102 to determine the most efficient redistribution server 104 will ease the burden on network administrators, reduce the potential for human error, and increase the efficiency of the computer network.

A client computer 102 may determine the most efficient redistribution server 104 to download software package 105 from by determining the number of intermediate network components between client computer 102 and each redistribution server 104. The client computer 102 may determine the number of intermediate network components by determining a hop count from client computer 102 to redistribution server 104. A client computer 102 may determine a hop count between the client computer 102 and redistribution server 104 by sending a packet to redistribution server 104 that includes a time-to-live parameter and a request for a response from redistribution server 104. In a particular embodiment this packet may be an ICMP echo request packet, or a PING packet. In alternative embodiments, the packet may be any packet capable of soliciting a response from redistribution server 104 while including information on the number of hops between client computer 102 and redistribution server 104.

Any client computer 102 may individually determine the hop count to each redistribution server 104 available to the client computer 102. Taking as an example client computer 102a, client computer 102a may send a packet to redistribution server 104a. This packet will first pass through and be directed by router 106a. A time-to-live parameter of the packet is set by client computer 102a when client computer 102a sends the packet. Router 106a will decrement the time-to-live parameter by one before forwarding the packet to redistribution server 104a. If router 106a determines that the time-to-live parameter is zero, router 106a will send a message undeliverable reply to client computer 102a and not forward the packet to redistribution server 104a.

For example, if client computer 102a sets a time-to-live parameter of a packet to one and sends the packet to redistribution server 104a, router 106a will decrement the time-to-live parameter by one, realize that the time-to-live parameter is now set to zero, and send a message undeliverable reply to client computer 102a. In response to the message undeliverable reply, client computer 102a will increase the time-to-live parameter of the first packet by one such that the time-to-live parameter is now two and resend the packet to redistribution server 104a. Upon receiving this second packet, router 106a will decrement the time-to-live parameter to one and forward the packet to redistribution server 104a. Redistribution server 104a will then reply to client computer 102a with an acknowledge receipt message. For other redistribution servers 104 that are more than one hop from client computer 102a, client computer 102a may continue increasing the time-to-live parameter in response to receiving message undeliverable replies until the particular redistribution server 104 acknowledges receipt of the packet. Upon receipt of an acknowledgement message, client computer 102a will be able to determine the number of hops between client computer 102a and redistribution server 104a. Client computer 102a may subtract one from the time-to-live parameter and know the number of hops to redistribution server 104a. In the case of redistribution server 104n, the time to live parameter would be set to n+1 to receive an acknowledge receipt message from redistribution server 104n, and the number of hops would be n hops. Client computer 102a may repeat the determination of the number of hops for each redistribution server 104. The number of hops between a client computer 102 and a redistribution server 104 is known as a hop count and the two descriptions are used interchangeably for the purposes of this description.

In particular embodiments, a maximum hop count may be determined by specifying a maximum time-to-live parameter. This will prevent client computer 102 from continually sending increasing time-to-live parameter packets to a redistribution server 104 that is unavailable.

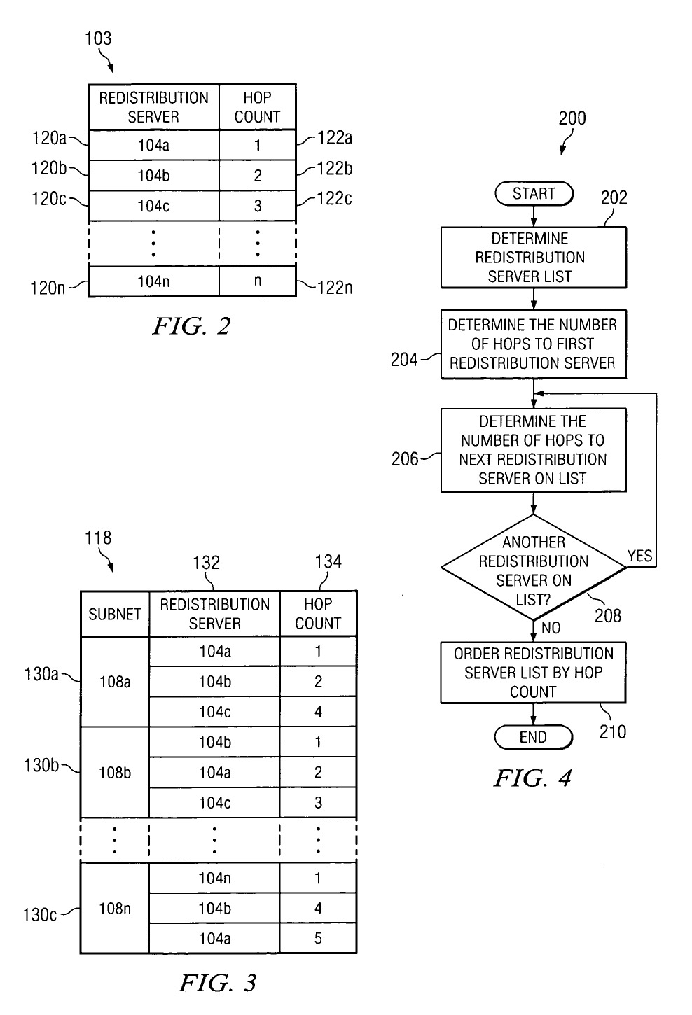

The results of determining the hop count to each redistribution server 104 may be tabulated into a hop count table 103 as illustrated in FIG. 2. Each redistribution server available to a client computer 102 may be assigned an identifier 120. Identifiers 120 are illustrated in FIG. 2 as simply 104a, 104b, 104c, . . . and 104n. In a large network, any number of redistribution servers may be available to a particular client computer 102, and any identifier 120 may be used to designate a particular redistribution server. Furthermore, identifiers 120 may be designations assigned to redistribution servers 104 by the particular client computer 102 compiling hop count table 103, or may be an identifier common across the network, such as a redistribution server's name on the network.

Hop count table 103 also includes a second column for a hop count 122. Hop count table 103 may order the redistribution servers 104 in ascending order according to their hop count 122. When a particular client computer 102 needs to determine from which redistribution server 104 to download software package 105, client computer 102 consults its version of hop count table 103 to determine the most efficient redistribution server 104 from which to download software package 105. The most efficient redistribution server 104 will generally be the redistribution server 104 with the lowest hop count 122.

FIG. 2 illustrates a hop count table 103 that may be compiled by client computer 102a. As illustrated in FIG. 2, redistribution server 104a has the lowest hop count 122a of one. Therefore, client computer 102a would first attempt to download software package 105 from redistribution server 104a. If redistribution server 104a is unavailable, client computer 102a would move to the redistribution server listed in hop count table 103 with the next lowest hop count 122b. As illustrated in FIG. 2, this would be redistribution server 104b with hop count 122b of two. Client computer 102a may continue down the list of redistribution servers 104 listed in hop count table 103 in ascending order of hop count 122 until an available redistribution server is located. If two or more redistribution servers 104 are equal hop counts away from a particular client computer 102, the redistribution servers are tied for priority on hop count table 103. The order that the tied redistribution servers are listed on hop count table 103 is not important and any method of resolving ties and determining which of the tied redistribution servers 104 to list first would fall within the scope of the present invention.

In particular embodiments, each client computer 102 may compile its own hop count table 103. Alternatively, client computers 102 that are similarly situated, such as, for example, client computers 102b within subnet 108a, may have a representative client computer 102b compile hop count table 103 for sharing amongst the subnet 108a. The compiling and sharing of hop count table 103 may be the responsibility of a client computer 102b or may be handled by an administration server 116. When an administration server 116 directs the compiling of hop count table 103, the administration server 116 may designate a particular client computer 102b of subnet 108a to determine the hop count between subnet 108a and each redistribution server 104. The designated client computer 102b may determine the hop count to each redistribution server 104 as described above and report the results to administration server 116. Administration server 116 may then compile a hop count table 103 or take the hop count table 103 compiled by the designated client computer 102b and communicate it to the other client computers 102b. Alternatively, administration server 116 may keep the hop count table 103 resident on administration server 116 and make it available to client computers 102b.

Administration server 116 may repeat the above described steps for each subnet, such as subnet 108b, of the computer network. Administration server 116 may then compile a subnet table 118 as illustrated in FIG. 3. A subnet identifier 130 may be cross-referenced with the redistribution server identifier 132 of each redistribution server 104 available to the subnet 108 and the hop count 134 to each of those redistribution servers 104. Subnet table 118 may be resident on administration server 116 or accessible by administration server 116. Subnet table 118 may be referenced by administration server 116 to direct client computers 102 of a particular subnet 108 as to which distribution server 104 should be used to download software package 105. If administration server 116 receives a request from a client computer 102 included in a subnet 108 not identified in subnet table 118, administration server 116 may direct the client computer 102 to determine the hop count to each redistribution server 104 and include this information in subnet table 118. Administration server 116 may also be aware of changes in network topology that would require updating of subnet table 118. To update subnet table 118 administration server 116 may direct a representative client computer 102 of each subnet 108 to perform the hop count determination and report the results to administration server 116.

The entries in hop count table 103 or subnet table 118 may be periodically updated to ensure that the most current information is available to client computers 102. This may be important because new redistribution servers 104 may have been added, the network topology may have changed, or a particular redistribution server 104 may have been unavailable when the prior hop count determination was performed. Additionally, a list of all available redistribution servers 104 may be provided to administration server 116, and this list may be updated as needed.

FIG. 4 illustrates a flowchart 200 of the steps taken to determine the hop counts from a particular client computer 102 to each redistribution server 104 available to client computer 102. At step 202, a list of redistribution servers available to client computer 102 is accessed. This list may be discovered from the network, provided by administration server 116, or may be provided by a network administrator. At step 204, the hop count to the first redistribution server 104 is determined. At step 206, the hop count to the next redistribution server 104 on the list is determined. Step 208 repeats the hop count determination until there are no more redistribution servers 104 on the redistribution server list. At step 210, the redistribution servers are reordered in order of ascending hop count. A client computer 102 may then reference the reordered redistribution server list and attempt to download any available software updates from the redistribution server with the lowest hop count. If the redistribution server with the lowest hop count is not available, the software may be requested from the redistribution server with the next lowest hop count, and so on until the client computer 102 is able to download the software. In an alternative embodiment, the redistribution server list is not reordered, but instead the client computers scan the list to determine the redistribution server with the lowest hop count.

Numerous other changes, substitutions, variations, alterations, and modifications may be ascertained by those skilled in the art and it is intended that the present invention encompass all such changes, substitutions, variations, alterations, and modifications as falling within the spirit and scope of the appended claims. Moreover, the present invention is not intended to be limited in any way by any statement in the specification that is not otherwise reflected in the claims.

What is claimed is:

1. A method of updating software on a client computer, comprising:
accessing a list of available redistribution servers in a network, wherein each redistribution server includes particular software for download;
determining a hop count between a client computer and a plurality of the redistribution servers on the list of available redistribution servers; and
requesting the software from a redistribution server with the lowest determined hop count.

2. The method of claim 1, wherein determining the hop count between the client computer and the plurality of the redistribution servers on the list of available redistribution servers comprises:
repeating the following for each of the plurality of the redistribution servers:
repeating the following until the redistribution server acknowledges receipt of a packet:
sending the packet to the redistribution server requesting that the redistribution server acknowledge receipt of the packet; and
incrementing a time-to-live parameter of the packet in response to a delivery failure notification from an intermediate network component; and
associating the redistribution server with the time-to-live parameter, the time-to-live parameter corresponding to the hop count between the client computer and the redistribution server.

3. The method of claim 2, further comprising:
compiling a list of the redistribution servers and their associated hop counts; and
making the list of the redistribution servers and their associated hop counts available to a plurality of clients in a subnet of the network.

4. The method of claim 3, wherein the compiling is accomplished by the client computer.

5. The method of claim 3, wherein the compiling is accomplished by an administration server that is responsible for the subnet.

6. The method of claim 2, wherein the packet is an ICMP echo request PING packet.

7. The method of claim 1, wherein the software includes virus signature files.

8. A method of updating software on a network, comprising:
accessing a list of subnets, the subnets including at least one client computer;
accessing a list of redistribution servers available to each subnet;
directing a first client computer on at least one subnet to determine a first hop count between the first client computer and a first redistribution server available to the at least one subnet;
directing the first client computer on the at least one subnet to determine a second hop count between the first client computer and a second redistribution server available to the at least one subnet; and
compiling a table associating the first redistribution server with the first hop count and associating the second redistribution server with the second hop count.

9. The method of claim 8, further comprising communicating the table to a plurality of client computers on the at least one subnet.

10. The method of claim 8, further comprising:
receiving a request at an administration server from a second client computer of the at least one subnet for an identifier of the redistribution server available to the at least one subnet that has the lowest hop count; and
providing to the second client computer of the at least one subnet an identifier of the redistribution server available to the at least one subnet that has the lowest hop count.

11. The method of claim 8, wherein directing the first client computer on the at least one subnet to determine the first hop count between the first client computer and the first redistribution server available to the at least one subnet comprises:
repeating the following until the first redistribution server acknowledges receipt of a packet:
sending the packet to the first redistribution server requesting that the first redistribution server acknowledge receipt of the packet; and
incrementing a time-to-live parameter of the packet in response to a delivery failure notification from an intermediate network component; and
associating the first redistribution server with the time-to-live parameter, the time-to-live parameter corresponding to the hop count between the first client computer and the first redistribution server.

12. The method of claim 8, further comprising repeating the following for each of a plurality of subnets on the list of subnets:
directing a client computer in a subnet of the plurality of subnets to determine a first hop count between the client computer and a first redistribution server available to the subnet of the plurality of subnets;
directing the client computer in the subnet of the plurality of subnets to determine a second hop count between the client computer and a second redistribution server available to the subnet of the plurality of subnets; and
compiling a table associating the first redistribution server with the first hop count and associating the second redistribution server with the second hop count.

13. The method of claim 8, further comprising:
accessing the table to determine a redistribution server available to the at least one subnet that has the lowest hop count; and
requesting software from the redistribution server available to the at least one subnet that has the lowest hop count.

14. The method of claim 13, wherein the software includes virus signature files.

15. A network for updating software on a client computer, comprising:
a plurality of redistribution servers, each redistribution server including particular software for download; and
at least one client computer operable to:
determine a hop count between the client computer and each of the plurality of redistribution servers; and
request the software from the one of the plurality of redistribution servers with the lowest determined hop count.

16. The network of claim 15, wherein the client computer operable to determine the hop count between the client computer and the plurality of redistribution servers comprises the client computer operable to:
repeat the following for each of the plurality of the redistribution servers:
repeat the following until the redistribution server acknowledges receipt of a packet:
send the packet to the redistribution server and request that the redistribution server acknowledge receipt of the packet; and
increment a time-to-live parameter of the packet in response to a delivery failure notification from an intermediate network component; and
associate the redistribution server with the time-to-live parameter, the time-to-live parameter corresponding to the hop count between the client computer and the redistribution server.

17. The network of claim 16, further comprising a hop count table listing the plurality of redistribution servers and their associated hop counts, the hop count table being available to a plurality of client computers in a subnet of the network.

18. The network of claim 17, wherein the hop count table resides on one of the plurality of client computers in the subnet of the network.

19. The network of claim 17, wherein the hop count table resides on an administration server that is responsible for the subnet of the network.

20. The network of claim 16, wherein the packet is an ICMP echo request PING packet.

21. The network of claim 15, wherein the software includes virus signature files.

22. A system for updating software on a network, comprising:
a plurality of subnets, each of the plurality of subnets including at least one client computer;
a list of redistribution servers available to each subnet;
an administration server coupled to the plurality of subnets and operable to:
direct a first client computer on one of the plurality of subnets to determine a first hop count between the first client computer and a first redistribution server available to the one of the plurality of subnets;
direct the first client computer to determine a second hop count between the first client computer and a second redistribution server available to the one of the plurality of subnets; and
compile a subnet table associating the first redistribution server with the first hop count and associating the second redistribution server with the second hop count.

23. The system of claim 22, further comprising communicating the table to a plurality of client computers on the one of the plurality of subnets.

24. The system of claim 22, further comprising the administration server further operable to:
receive a request from a second client computer on the one of the plurality of subnets for an identifier of a redistribution server available to the one of the plurality of subnets that has the lowest hop count; and
provide to the second client computer an identifier of the redistribution server available to the one of the plurality of subnets that has the lowest hop count.

25. The system of claim 22, wherein the administration server operable to direct the first client computer on one of the plurality of subnets to determine the first hop count between the first client computer and the first redistribution server available to the one of the plurality of subnets comprises:
repeating the following until the first redistribution server acknowledges receipt of a packet:
sending the packet to the first redistribution server requesting that the first redistribution server acknowledge receipt of the packet; and
incrementing a time-to-live parameter of the packet in response to a delivery failure notification from an intermediate network component; and
associating the first redistribution server with the time-to-live parameter, the time-to-live parameter corresponding to the hop count between the first client computer and the first redistribution server.

26. The system of claim 22, wherein the first client computer is further operable to:
access the subnet table to determine a redistribution server available to the one of the plurality of subnets that has the lowest hop count; and
request software from the redistribution server available to one of the plurality of subnets that has the lowest hop count.

27. The system of claim 26, wherein the software includes virus signature files.
